(19) United States
(12) Patent Application Publication
(10) Pub. No.: US 2024/0337443 A1
(43) Pub. Date: Oct. 10, 2024

(54) MATERIAL FOR ACTIVE MATERIAL KILN AND KILN INCLUDING SAME

(71) Applicant: L&F CO., LTD., Daegu (KR)

(72) Inventors: Sung Woo CHO, Daegu (KR); Sung Kyun CHANG, Daegu (KR); Hyuk Won KWON, Daegu (KR); Ji Woo OH, Daegu (KR); Doe Hyoung KIM, Daegu (KR); Hyeon Cheol JEONG, Daegu (KR)

(21) Appl. No.: 18/575,922

(22) PCT Filed: Jun. 28, 2022
(86) PCT No.: PCT/KR2022/009203

§ 371 Date: Feb. 13, 2024

(30) Foreign Application Priority Data
Jul. 2, 2021 (KR) 10-2021-0087178

(51) Int. Cl. F27B 5/08; C22C 19/05

(52) U.S. Cl. CPC F27B 5/08; C22C 19/05

(57) ABSTRACT

Disclosed is a kiln having a portion with which raw materials for preparing active materials and/or the prepared active materials come into contact during firing, the portion containing a substance represented by the following Formula 1:

NiₐX_{z} (1)
wherein
a and z are weight fractions satisfying 0.85≤a<1 and 0<z≤0.15, respectively; and
X includes at least one element selected from the group consisting of Cr, Fe, Co, Mn, P, Cu, Mo, Si, Nb, Ti, W, C, Na, Al, Mg, Zn, B, Ta, O, Sn, Ag, Re, Ru and Zr, or an alloy or compound of at least two elements selected therefrom.

### TECHNICAL FIELD

The present invention relates to a novel substance for an active material kiln and a kiln containing the same.

### BACKGROUND ART

In general, heat treatment is performed using a continuous firing furnace called a “roller hearth kiln (RHK)” in the process of producing a cathode active material. The roller hearth kiln extends lengthwise in the horizontal direction and is divided into several zones, wherein the temperature can be set for each zone and thus the firing temperature is set so as to be gradually elevated or lowered.

When a powdery lithium source is mixed with a metal source and a firing vessel containing the resulting mixture is fed into a roller hearth kiln, continuous firing is performed while the firing vessel moves along the rail. During the firing process, the lithium source reacts with the metal source to produce an active material.

However, the roller hearth kiln has several problems such as poor productivity attributable to the very long firing time due to facility limitations, non-uniform reaction due to lack of fluidity of raw materials, and many spatial restrictions.

Recently, an attempt has been made to produce a cathode active material using a rotary kiln (RK) rather than the roller hearth kiln (RHK).

A rotary kiln is a device for preparing an active material by feeding a lithium source and a metal source into a cylindrical kiln (retort) disposed at a slight angle and continuously applying external heat thereto while rotating the retort.

The active material fed into the cylindrical retort tube moves little by little toward an outlet located at the opposite end of an inlet as the retort rotates in an inclined state. The rotation of the retort enables continuous mixing during the firing process, so that a homogeneous reaction is possible, the production time can be dramatically shortened, and thus production can be maximized.

The retort of the rotary kiln is generally made of SUS or Inconel. SUS contains Fe as a main component, 28% or less of Ni, 11 to 32% of Cr, and traces of other elements. Inconel, which is a heat-resistant alloy, contains Ni as a main component, 14 to 15% of Cr, 6 to 7% of Fe, and traces of other elements.

The fired active material undergoes impurity inspection. Since impurities such as Fe and Cr adversely affect the performance of the secondary battery, it is very important to set a reference value for the upper limit of an impurity content and control the impurity content within not more than the reference value.

However, the rotary kiln has several advantages described above, but has a problem in that high amounts of impurities such as Fe and Cr are detected in the prepared active material.

This is considered to be because raw materials such as LiOH, Li₂CO₃, and NCM(OH)₂ used as active material precursors are basic and thus corrosion occurs due to reaction with the metal material for the retort at high temperature and in an oxidizing atmosphere, and elements constituting the retort are desorbed or eluted, thus contaminating the active material, due to various factors such as abrasion of the inner surface of the retort while the inner wall of the high-temperature retort continuously contacts the active material by rotation.

Incorporation into the active material due to desorption or elution of the impurities not only adversely affects the active material and the secondary battery including the same, but also greatly reduces the lifespan of the retort. Accordingly, there is an increasing need for a novel technology capable of solving these problems.

### DISCLOSURE

### Technical Problem

Therefore, the present invention has been made to solve the above and other technical problems that have yet to be solved.

Therefore, as a result of extensive research and various experiments, the present inventors found that, when the areas of the kiln for preparing active materials where raw materials for preparing active materials or the prepared active materials come into contact contain a specific substance, high-quality active materials can be prepared by remarkably suppressing the incorporation of impurities into the active materials during firing of the active materials and the lifespan of the kiln can also be improved due to excellent abrasion resistance. The present invention was completed based thereon.

### Technical Solution

In accordance with an aspect of the present invention, provided is a kiln having a portion with which raw materials for preparing active materials and/or the prepared active materials come into contact during firing, the portion containing a substance (substance for an active material kiln) represented by the following Formula 1:

NiₐX_{z} (1)

wherein

a and z are weight fractions satisfying 0.85≤a<1 and 0<z<0.15, respectively; and

X is at least one element selected from the group consisting of Cr, Fe, Co, Mn, P, Cu, Mo, Si, Nb, Ti, W, C, Na, Al, Mg, Zn, B, Ta, O, Sn, Ag, Re, Ru and Zr, or an alloy or compound of at least two elements selected therefrom.

Unless otherwise specified herein, the content of elements is based on a weight ratio.

The kiln having characteristics according to the present invention suppresses the incorporation of impurities such as Fe and Cr derived from the retort into the active material during firing for preparing an active material, thereby enabling preparation of an active material with excellent physical properties, improving the lifespan of the active material owing to excellent resistance to surface abrasion and ultimately reducing the preparation cost of the active material.

As described above, the kiln of the present invention may be applied to various types of kilns, and in particular, may be preferably applied to rotary kilns with which raw materials for preparing active materials and/or prepared active materials actively contact during firing.

In the description of component X in Formula 1, the term “alloy” refers to a combination of elements having a metal bond between metal elements or between a metal element and a non-metal element, and the term “compound” refers to a combination of elements having a covalent bond or the like other than a metal bond between non-metal elements. A representative example of the metal bond between the metal element and the non-metal element is WC.

Therefore, overall, NiₐX_{z} of Formula 1 may be understood as a nickel alloy containing component X as an element, an alloy or a compound and preferably, as a Ni alloy containing component X as an element or an alloy.

The terms “alloy” and “compound” which will be explained later are also interpreted as defined above unless otherwise explained herein.

In one specific example, the kiln of the present invention may contain a substance (substance for an active material kiln) represented by the following Formula 2:

NiₐCr_{b}Fe_{c}Mn_{d}NbₑSi_{f}C_{g}CoₕCuᵢX_{z} (2)

wherein a, b, c, d, e, f, g, h and i are weight fractions satisfying 0.85≤a<1, and 0<b+c+d+e+f+g+h+i≤0.15; and

X includes at least one element selected from the group consisting of W, P, Mo, Ti, Na, Al, Mg, Zn, B, Ta, O, Sn, Ag, Re, Ru and Zr, or an alloy or compound of at least two elements selected therefrom.

In another specific example, the kiln of the present invention may contain a substance (substance for an active material kiln) represented by the following Formula 3.

NiₐWⱼCₖPₗMoₘTiₙX_{z} (3)

wherein a, j, k, 1, m and n are weight fractions satisfying 0.85≤a<1.0, and 0<j+k+1+m+n≤0.15; and

X includes at least one element selected from the group consisting of Cr, Fe, Co, Mn, Cu, Si, Nb, Na, Al, Mg, Zn, B, Ta, O, Sn, Ag, Re, Ru and Zr, or an alloy or compound of at least two elements selected therefrom.

In Formulas 1 to 3, the content of Ni is preferably in the range of 0.9≤a<1. In addition, in Formula 2, the content of Cr is preferably in the range of 0.01≤b≤0.1.

As defined above, the kiln according to the present invention has a portion with which the raw materials for preparing active materials and/or the prepared active materials come into contact during the firing process and the portion contains a specific substance (substance for an active material kiln).

The portion where the raw materials for preparing active materials and/or the prepared active materials come into contact may be formed as a coating layer inside the kiln, or an inner wall including the portion may be used. Here, the inner wall refers to a structure that is located inside the kiln and is physically/chemically distinguishable from the kiln.

Accordingly, the inner wall or coating layer of the portion may be entirely or partially made of the substance described above.

When the outer wall of the kiln contains the substance described above, the outer wall may be based on, for example, SUS or Inconel known in the art. For example, when the kiln includes a cylindrical retort, the thickness of the inner wall may range from 0.01% to 90%, specifically 0.1 to 80%, based on the thickness of the cylindrical retort. When the thickness of the inner wall is less than 0.01%, the kiln may be readily damaged by physical impact. When the thickness of the inner wall exceeds 90%, the part other than the inner wall becomes thin, which may reduce the durability of the kiln and make precise control of the kiln temperature difficult.

The thickness of the coating layer may be in the range of 0.05 mm to 2 mm, and more preferably in the range of 0.1 mm to 1 mm. When the thickness is less than 0.05 mm, the effectiveness of the coating layer rapidly deteriorates, thus making it difficult to obtain practical effects and being readily peeled off due to friction with the raw material. Experiments performed by the present inventors confirmed that there was almost no elution of Fe and Cr when the coating layer thickness was set to 2 mm. Therefore, the thickness is preferably 2 mm or less.

The coating layer may be formed using a variety of methods, for example, including, but not limited to, physical vapor deposition (PVD) such as sputtering, electron beam, cathode arc method, thermal evaporation, ion beam, chemical vapor deposition (CVD) such as chemical vapor deposition (PECVD), various plating methods, and various spray coating methods such as arc spraying, powder spraying, plasma spraying, cold spraying, and ultra-high-speed spraying.

In one specific example, the kiln according to the present invention satisfies the following requirement of (a) to (c) within a temperature range of 600°° C. to 900°° C. when ICP-MS analysis is performed on the active material heat-treated under the following conditions:
(a) an Fe content is less than 20 ppm, or
(b) a Cr content is less than 20 ppm, or
(c) both (a) and (b).

### [Conditions]

Specimen type: SUS310S
Specimen size: 100 mm×100 mm×20 mm (width×length×height)
Active material firing: 10 g of active material is uniformly loaded on the surface of the specimen, placed in a kiln, fired at an elevated temperature to the range of 600°° C. to 900°° C. at a rate of 5° C./min in an oxygen atmosphere for 8 hours and slowly cooled to room temperature.

This aims at testing with a specimen with a small size under conditions as similar as possible when it is not easy to apply the substance for a kiln according to the present invention directly to a kiln that has a size of several meters to tens of meters and conduct repeated experiments. When tested under these conditions, impurities were detected at an amount less than 20 ppm as can be seen from Tables 1 and 2 described later.

In another specific example, the kiln according to the present invention satisfies the following requirement of (a) to (c) within a temperature range of 600° C. to 900°° C. when ICP-MS analysis is performed on the active material heat-treated under the following conditions:
(a) an Fe content is less than 20 ppm, or
(b) a Cr content is less than 20 ppm, or
(c) both (a) and (b).
   [conditions]
Active material firing: 500 kg to 3,000 kg of an active material is fired in a kiln at an elevated temperature of 600°° C. to 900°° C. at a rate of 5° C./min in an oxygen atmosphere for 1 to 8 hours and slowly cooled to room temperature.

This aims at determining whether or not the results obtained from the testing with a specimen with a size of 100 mm×100 mm×20 mm are the same as the results from testing with an actual kiln. The results of analysis by the present inventors were almost similar to those of Table 1 and Table 2 described below.

The present invention also provides the substance for an active material kiln as described above. Specifically, the present invention provides a substance for an active material kiln that is contained in a portion of the kiln with which the raw materials for preparing active materials and/or the prepared active materials come into contact during the firing process and the substance is represented by the following Formula 1:

NiₐX_{z} (1)

wherein

a and z are weight fractions satisfying 0.85≤a<1 and 0<z≤0.15, respectively; and

X is at least one element selected from the group consisting of Cr, Fe, Co, Mn, P, Cu, Mo, Si, Nb, Ti, W, C, Na, Al, Mg, Zn, B, Ta, O, Sn, Ag, Re, Ru and Zr, or an alloy or compound of at least two elements selected therefrom.

In one specific example, the substance for an active material kiln may include at least one selected from the group consisting of substances represented by the following Formula 2 and Formula 3:

NiₐCr_{b}Fe_{c}Mn_{d}NbₑSi_{f}C_{g}CoₕCuᵢX_{z} (2)

wherein a, b, c, d, e, f, g, h and i are weight fractions satisfying 0.85≤a<1, and 0<b+c+d+e+f+g+h+i≤0.15; and

X includes at least one element selected from the group consisting of W, P, Mo, Ti, Na, Al, Mg, Zn, B, Ta, O, Sn, Ag, Re, Ru and Zr, or an alloy or compound of at least two elements selected therefrom, and

NiₐWⱼCₖPₗMoₘTiₙX_{z} (3)

wherein a, j, k, l, m and n are weight fractions satisfying 0.85≤a<1.0, and 0<j+k+1+m+n ≤0.15; and

X includes at least one element selected from the group consisting of Cr, Fe, Co, Mn, Cu, Si, Nb, Na, Al, Mg, Zn, B, Ta, O, Sn, Ag, Re, Ru and Zr, or an alloy or compound of at least two elements selected therefrom.

Detailed descriptions of these materials are replaced with the corresponding descriptions as to the kiln.

### Effects of the Invention

As described above, the substance for an active material kiln according to the present invention constituting a predetermined portion of the kiln and the kiln containing the same dramatically suppress the incorporation of impurities such as Fe and Cr into the active material during firing for preparing the active material, thus enabling the preparation of active materials with excellent physical properties.

### BEST MODE

Now, the present invention will be described in more detail with reference to the following examples and drawings. These examples should not be construed as limiting the scope of the present invention.

### Comparative Example 1

An SUS 310S specimen, one of the materials for a retort of a rotary kiln, was prepared in a size of 100 mm×100 mm×20 mm (width×length×height), 10 g of a cathode active material (Li_{1.03}Ni_{0.70}Co_{0.15}Mn_{0.15}O₂) was uniformly loaded onto the entire surface of the specimen, and the resulting specimen was fed into a kiln, heated to a temperature of 600° C. at a rate of 5° C./min in an oxygen atmosphere and then fired for 8 hours.

When firing was completed, the specimen was slowly cooled to room temperature, the active material was collected, and ICP-MS (inductively coupled plasma mass spectroscopy) analysis was performed.

10 g of a fresh cathode active material (Li_{1.03}Ni_{0.70}Co_{0.15}Mn_{0.15}O₂) was uniformly loaded on the surface of the specimen, and the resulting specimen was fed into a kiln, heated to a temperature to 675° C. at a rate of 5° C./min in an oxygen atmosphere and then fired for 8 hours.

When firing was completed, the specimen was cooled to room temperature and was taken out, the active material was collected, and ICP-MS analysis was performed.

This process was repeatedly performed at 600° C., 675° C., 700°° C., 725° C., 775° C., 800°° C., 825°° C., and 900° C.

### Comparative Example 2

Firing and analysis were performed under the same conditions as in Comparative Example 1, except that the type of specimen as a retort material was changed to an Inconel specimen.

### Comparative Example 3

Firing and analysis were performed under the same conditions as in Comparative Example 1, except that the type of specimen as a retort material was changed to an alloy having a composition (weight ratio) of Ni 55 wt %, Cr 15 wt % and Fe 30 wt %.

### Comparative Example 4

Firing and analysis were performed under the same conditions as in Comparative Example 1, except that the type of specimen as a retort material was changed to an alloy having a composition (weight ratio) of Ni 63 wt %, Cr 22 wt % and Fe 15 wt %.

### Comparative Example 5

Firing and analysis were performed under the same conditions as in Comparative Example 1, except that the type of specimen as a retort material was changed to an alloy having a composition (weight ratio) of Ni 80 wt %, Cr 14 wt % and Fe 6 wt %.

### Example 1

Firing and analysis were performed under the same conditions as in Comparative Example 1, except that the type of specimen as a retort material was changed to an alloy having a composition (weight ratio) of Ni 90 wt %, Cr 6 wt % and Fe 4 wt %.

### Example 2

Firing and analysis were performed under the same conditions as in Comparative Example 1, except that the type of specimen as a retort material was changed to an alloy having a composition (weight ratio) of Ni 90 wt %, Mn 6 wt % and Si 4 wt %.

### Example 3

Firing and analysis were performed under the same conditions as in Comparative Example 1, except that the type of specimen as a retort material was changed to an alloy having a composition (weight ratio) of Ni 90 wt %, Cr 4 wt %, C 1 wt % and Co 5 wt %.

### Example 4

Firing and analysis were performed under the same conditions as in Comparative Example 1, except that the type of specimen as a retort material was changed to an alloy having a composition (weight ratio) of Ni 97 wt % and Fe 3 wt %.

### Example 5

Firing and analysis were performed under the same conditions as in Comparative Example 1, except that the type of specimen as a retort material was changed to an alloy having a composition (weight ratio) of Ni 97 wt %, WC 2 wt %, and P 1 wt %.

### Example 6

Firing and analysis were performed under the same conditions as in Comparative Example 1, except that the type of specimen as a retort material was changed to an alloy having a composition (weight ratio) of Ni 97 wt %, Mn 2 wt %, and Cu 1 wt %.

### Example 7

Firing and analysis were performed under the same conditions as in Comparative Example 1, except that the type of specimen as a retort material was changed to an alloy having a composition (weight ratio) of Ni 99 wt % and Fe 1 wt %.

### Example 8

Firing and analysis were performed under the same conditions as in Comparative Example 1, except that the type of specimen as a retort material was changed to an alloy having a composition (weight ratio) of Ni 99 wt % and Mo 1 wt %.

### Example 9

Firing and analysis were performed under the same conditions as in Comparative Example 1, except that the type of specimen as a retort material was changed to an alloy having a composition (weight ratio) of Ni 99 wt % and Si 1 wt %.

### Example 10

Firing and analysis were performed under the same conditions as in Comparative Example 1, except that the type of specimen as a retort material was changed to an alloy having a composition (weight ratio) of Ni 99 wt %, Fe 0.5 wt % and Mn 0.5 wt %.

### Example 11

Firing and analysis were performed under the same conditions as in Comparative Example 1, except that the type of specimen as a retort material was changed to an alloy having a composition (weight ratio) of Ni 99 wt %, Fe 0.4 wt %, Cr 0.5 wt % and Nb 0.1 wt %.

### Example 12

Firing and analysis were performed under the same conditions as in Comparative Example 1, except that the type of specimen as a retort material was changed to an alloy having a composition (weight ratio) of Ni 99 wt % and Ti 1 wt %.

### Example 13

Firing and analysis were performed under the same conditions as in Comparative Example 1, except that the type of specimen as a retort material was changed to an alloy having a composition (weight ratio) of Ni 99.8 wt % and Fe 0.2 wt %.

### Example 14

Firing and analysis were performed under the same conditions as in Comparative Example 1, except that the type of specimen as a retort material was changed to an alloy having a composition (weight ratio) of Ni 85 wt % and Cr 15 wt %.

### Example 15

Firing and analysis were performed under the same conditions as in Comparative Example 1, except that the type of specimen as a retort material was changed to an alloy having a composition (weight ratio) of Ni 85 wt %, Cr 7 wt %, Si 4 wt % and Fe 4 wt %.

### Example 16

Firing and analysis were performed under the same conditions as in Comparative Example 1, except that the type of specimen as a retort material was changed to an alloy having a composition (weight ratio) of Ni 90 wt % and Cr 10 wt %.

### Example 17

Firing and analysis were performed under the same conditions as in Comparative Example 1, except that the type of specimen as a retort material was changed to an alloy having a composition (weight ratio) of Ni 90 wt %, Cr 5 wt %, Si 2.5 wt % and Fe 2.5 wt %.

### Example 18

Firing and analysis were performed under the same conditions as in Comparative Example 1, except that the type of specimen as a retort material was changed to an alloy having a composition (weight ratio) of Ni 95 wt % and Cr 5 wt %.

### Example 19

Firing and analysis were performed under the same conditions as in Comparative Example 1, except that the type of specimen as a retort material was changed to an alloy having a composition (weight ratio) of Ni 95 wt %, Cr 3 wt %, Si 1 wt % and Fe 1 wt %.

### Experimental Example 1

The results of the ICP-MS analysis performed in Comparative Examples 1 to 5 and Examples 1 to 19 are shown in Tables 1 and 2 below. Table 1 shows the result of ICP-MS analysis for the Fe content and Table 2 shows the result of ICP-MS analysis for the Cr content.

TABLE 1

| | Fe (ppm) | | | | | | | |
|---|---|---|---|---|---|---|---|---|
| | 600° | 675° | 700° | 725° | 775° | 800° | 825° | 900° |
| Item | C. | C. | C. | C. | C. | C. | C. | C. |
| Comparative | 0 | 0 | 10 | 56 | 198 | 485 | 924 | 3801 |
| Example 1 | | | | | | | | |
| Comparative | 0 | 0 | 4 | 46 | 74 | 705 | 1010 | 2315 |
| Example 2 | | | | | | | | |
| Comparative | 0 | 0 | 15 | 35 | 185 | 501 | 846 | 3605 |
| Example 3 | | | | | | | | |
| Comparative | 0 | 0 | 8 | 63 | 145 | 680 | 754 | 3910 |
| Example 4 | | | | | | | | |
| Comparative | 0 | 0 | 6 | 24 | 41 | 195 | 451 | 785 |
| Example 5 | | | | | | | | |
| Example 1 | 0 | 0 | 0 | 1 | 3 | 5 | 6 | 15 |
| Example 2 | 0 | 0 | 0 | 0 | 0 | 0 | 0 | 0 |
| Example 3 | 0 | 0 | 0 | 0 | 0 | 0 | 0 | 0 |
| Example 4 | 0 | 0 | 0 | 0 | 1 | 5 | 5 | 9 |
| Example 5 | 0 | 0 | 0 | 0 | 0 | 0 | 0 | 0 |
| Example 6 | 0 | 0 | 0 | 0 | 0 | 0 | 0 | 0 |
| Example 7 | 0 | 0 | 0 | 0 | 1 | 4 | 6 | 9 |
| Example 8 | 0 | 0 | 0 | 0 | 0 | 0 | 0 | 0 |
| Example 9 | 0 | 0 | 0 | 0 | 0 | 0 | 0 | 0 |
| Example 10 | 0 | 0 | 0 | 0 | 0 | 0 | 4 | 6 |
| Example 11 | 0 | 0 | 0 | 0 | 0 | 0 | 4 | 8 |
| Example 12 | 0 | 0 | 0 | 0 | 0 | 0 | 0 | 0 |
| Example 13 | 0 | 0 | 0 | 0 | 0 | 4 | 5 | 8 |
| Example 14 | 0 | 0 | 0 | 0 | 1 | 2 | 5 | 9 |
| Example 15 | 0 | 0 | 0 | 0 | 0 | 1 | 6 | 6 |
| Example 16 | 0 | 0 | 0 | 0 | 0 | 0 | 0 | 0 |
| Example 17 | 0 | 0 | 0 | 0 | 1 | 3 | 4 | 7 |
| Example 18 | 0 | 0 | 0 | 0 | 0 | 0 | 0 | 0 |
| Example 19 | 0 | 0 | 0 | 0 | 0 | 2 | 3 | 5 |

TABLE 2

| | Cr (ppm) | | | | | | | |
|---|---|---|---|---|---|---|---|---|
| | 600° | 675° | 700° | 725° | 775° | 800° | 825° | 900° |
| Item | C. | C. | C. | C. | C. | C. | C. | C. |
| Comparative | 750 | 971 | 998 | 3215 | 4902 | 6824 | 9146 | 12001 |
| Example 1 | | | | | | | | |
| Comparative | 485 | 590 | 645 | 1425 | 2914 | 4620 | 7202 | 12354 |
| Example 2 | | | | | | | | |
| Comparative | 680 | 868 | 945 | 3126 | 5014 | 6706 | 9004 | 11880 |
| Example 3 | | | | | | | | |
| Comparative | 576 | 784 | 887 | 3014 | 5246 | 6910 | 8988 | 11540 |
| Example 4 | | | | | | | | |
| Comparative | 195 | 248 | 326 | 621 | 984 | 1105 | 2264 | 3900 |
| Example 5 | | | | | | | | |
| Example 1 | 0 | 0 | 0 | 0 | 5 | 6 | 7 | 16 |
| Example 2 | 0 | 0 | 0 | 0 | 0 | 0 | 0 | 0 |
| Example 3 | 0 | 0 | 0 | 0 | 4 | 5 | 9 | 12 |
| Example 4 | 0 | 0 | 0 | 0 | 0 | 0 | 0 | 0 |
| Example 5 | 0 | 0 | 0 | 0 | 0 | 0 | 0 | 0 |
| Example 6 | 0 | 0 | 0 | 0 | 0 | 0 | 0 | 0 |
| Example 7 | 0 | 0 | 0 | 0 | 0 | 0 | 0 | 0 |
| Example 8 | 0 | 0 | 0 | 0 | 0 | 0 | 0 | 0 |
| Example 9 | 0 | 0 | 0 | 0 | 0 | 0 | 0 | 0 |
| Example 10 | 0 | 0 | 0 | 0 | 0 | 0 | 0 | 0 |
| Example 11 | 0 | 0 | 0 | 0 | 4 | 7 | 5 | 12 |
| Example 12 | 0 | 0 | 0 | 0 | 0 | 0 | 0 | 0 |
| Example 13 | 0 | 0 | 0 | 0 | 0 | 0 | 0 | 0 |
| Example 14 | 0 | 0 | 0 | 0 | 1 | 4 | 6 | 6 |
| Example 15 | 0 | 0 | 0 | 0 | 2 | 5 | 8 | 9 |
| Example 16 | 0 | 0 | 0 | 0 | 1 | 2 | 5 | 8 |
| Example 17 | 0 | 0 | 0 | 0 | 1 | 3 | 4 | 7 |
| Example 18 | 0 | 0 | 0 | 0 | 0 | 1 | 3 | 6 |
| Example 19 | 0 | 0 | 0 | 0 | 0 | 1 | 3 | 4 |

As the Ni content of the cathode active material increases, the firing temperature decreases. Recently, the demand for a high-Ni cathode active material having a Ni content of 60% or more has increased. The firing temperature of the cathode active material having a high Ni content is 900°° C. or less, mainly 850°° C. or less. That is, when preparing a cathode active material with a high Ni content using a rotary kiln, the elution of impurities such as Fe and Cr should be suppressed at a temperature of 900° C. or less.

As can be seen from Tables 1 and 2 above, the SUS310S specimen according to Comparative Example 1 and the Inconel specimen according to Comparative Example 2 exhibited increases in Fe and Co contents as the temperature rises to 900° C., and this phenomenon is also observed in the specimens of Comparative Examples 3 to 5 having a Ni content of 55% by weight to 80% by weight.

On the other hand, the specimens of Examples 1 to 19 having a Ni content of the retort of 85% by weight or more had Fe and Cr contents less than 20 ppm and exhibited an excellent effect of suppressing impurity elution even at temperatures up to 900° C.

### Experimental Example 2

The cathode active material was fired 10 times in the same manner as in Comparative Examples 1 to 5 and Examples 1 to 13 at a firing temperature of 900° C. and then the surface abrasion of the specimen was observed. The results are shown in Table 3 below.

TABLE 3

| | Type of retort | Surface state after 10 |
|---|---|---|
| Item | (specimen) (wt %) | repeated firing at 900° C. |
| Comparative | — | Severe surface abrasion |
| Example 1 | | |
| Comparative | — | Severe surface abrasion |
| Example 2 | | |
| Comparative | Ni55/Cr15/Fe30 | Severe surface abrasion |
| Example 3 | | |
| Comparative | Ni63/Cr22/Fe15 | Severe surface abrasion |
| Example 4 | | |
| Comparative | Ni80/Cr14/Fe6 | Severe surface abrasion |
| Example 5 | | |
| Example 1 | Ni90/Cr6/Fe4 | No surface abrasion |
| Example 2 | Ni90/Mn6/Si4 | Partial surface abrasion |
| Example 3 | Ni90/Cr 4/C1/Co5 | No surface abrasion |
| Example 4 | Ni97/Fe3 | No surface abrasion |
| Example 5 | Ni97/WC2/P1 | Partial surface abrasion |
| Example 6 | Ni97/Mn2/Cu1 | Partial surface abrasion |
| Example 7 | Ni99/Fe1 | No surface abrasion |
| Example 8 | Ni99/Mo1 | Partial surface abrasion |
| Example 9 | Ni99/Si1 | Partial surface abrasion |
| Example 10 | Ni99/Fe0.5/Mn0.5 | No surface abrasion |
| Example 11 | Ni99/Fe0.4/Cr 0.5/ | No surface abrasion |
| | Nb0.1 | |
| Example 12 | Ni99/Ti1 | Partial surface abrasion |
| Example 13 | Ni99.8/Fe0.2 | No surface abrasion |

As can be seen from Table 3 above, all of the specimens of Comparative Examples 1 to 5 had severe surface abrasion, whereas the specimens of Examples 1 to 13 had almost no or only partial surface abrasion.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A kiln having a portion with which raw materials for preparing active materials and/or the prepared active materials come into contact during firing, the portion comprising a substance represented by the following Formula 1:
NiₐX_{z} (1)
wherein
a and z are weight fractions satisfying 0.85≤a<1 and 0<z≤0.15, respectively; and
X includes at least one element selected from the group consisting of Cr, Fe, Co, Mn, P, Cu, Mo, Si, Nb, Ti, W, C, Na, Al, Mg, Zn, B, Ta, O, Sn, Ag, Re, Ru and Zr, or an alloy or compound of at least two elements selected therefrom.

2. The kiln according to claim 1, wherein the kiln comprises a substance represented by the following Formula 2:
NiₐCr_{b}Fe_{c}Mn_{d}NbₑSi_{f}C_{g}CoₕCuᵢX_{z} (2)
wherein a, b, c, d, e, f, g, h and i are weight fractions satisfying 0.85≤a<1, and 0<b+c+d+e+f+g+h+i≤0.15; and
X includes at least one element selected from the group consisting of W, P, Mo, Ti, Na, Al, Mg, Zn, B, Ta, O, Sn, Ag, Re, Ru and Zr, or an alloy or compound of at least two elements selected therefrom.

3. The kiln according to claim 1, wherein the kiln comprises a substance represented by the following Formula 3:
NiₐWⱼCₖPₗMoₘTiₙX_{z} (3)
wherein a, j, k, 1, m and n are weight fractions satisfying 0.85≤a<1.0, and 0<j+k+1+m+n≤0.15; and
X includes at least one element selected from the group consisting of Cr, Fe, Co, Mn, Cu, Si, Nb, Na, Al, Mg, Zn, B, Ta, O, Sn, Ag, Re, Ru and Zr, or an alloy or compound of at least two elements selected therefrom.

4. The kiln according to claim 1, wherein, in Formula 1, a satisfies the equation of 0.9≤a<1.

5. The kiln according to claim 2, wherein, in Formula 2, b satisfies the equation of 0.01≤b≤0.1.

6. The kiln according to claim 1, wherein the portion is formed in the form of a coating layer.

7. The kiln according to claim 1, wherein the kiln has an inner wall and the inner wall comprises a portion with which raw materials for preparing active materials and/or prepared active materials come into contact.

8. The kiln according to claim 6, wherein the coating layer has a thickness of 0.05 mm to 2 mm.

9. The kiln according to claim 7, wherein the kiln comprises a cylindrical retort and a thickness of the inner wall is 0.01 to 90% based on a thickness of the cylindrical retort.

10. The kiln according to claim 1, wherein the kiln satisfies the following requirement (a) to (c) within a temperature range of 600°° C. to 900°° C. when ICP-MS analysis is performed on the active material heat-treated under the following conditions:
(a) an Fe content is less than 20 ppm, or
(b) a Cr content is less than 20 ppm, or
(c) both (a) and (b).
[conditions]
Specimen type: SUS310S
Specimen size: 100 mm×100 mm×20 mm (width×length×height)
Active material firing: 10 g of an active material is uniformly loaded on a surface of the specimen, placed in a kiln, fired at an elevated temperature of 600° C. to 900° C. at a rate of 5° C./min in an oxygen atmosphere for 8 hours and slowly cooled to room temperature.

11. The kiln according to claim 1, wherein the kiln satisfies the following requirement (a) to (c) within a temperature range of 600°° C. to 900°° C. when ICP-MS analysis is performed on the active material heat-treated under the following conditions:
(a) an Fe content is less than 20 ppm, or
(b) a Cr content is less than 20 ppm, or
(c) both (a) and (b).
[conditions]
Active material firing: 500 kg to 3,000 kg of an active material is fired in a kiln at an elevated temperature of 600°° C. to 900°° C. at a rate of 5° C./min in an oxygen atmosphere for 1 to 8 hours and slowly cooled to room temperature.

12. A substance for an active material kiln present in a portion of the kiln with which raw materials for preparing active materials and/or the prepared active materials come into contact during firing, the substance being represented by the following Formula 1:
NiₐX_{z} (1)
wherein
a and z are weight fractions satisfying 0.85≤a<1 and 0<z≤0.15, respectively; and
X includes at least one element selected from the group consisting of Cr, Fe, Co, Mn, P, Cu, Mo, Si, Nb, Ti, W, C, Na, Al, Mg, Zn, B, Ta, O, Sn, Ag, Re, Ru and Zr, or an alloy or compound of at least two elements selected therefrom.

13. The substance according to claim 12, wherein the substance comprises at least one selected from the group consisting of substances represented by the following Formulas 2 and 3:
NiₐCn_{b}Fe_{c}Mn_{d}NbₑSi_{f}C_{g}CoₕCuᵢX_{z} (2)
wherein a, b, c, d, e, f, g, h and i are weight fractions satisfying 0.85≤a<1, and 0<b+c+d+e+f+g+h+i≤0.15; and
X includes at least one element selected from the group consisting of W, P, Mo, Ti, Na, Al, Mg, Zn, B, Ta, O, Sn, Ag, Re, Ru and Zr, or an alloy or compound of at least two elements selected therefrom,
NiₐWⱼCₖPₗMoₘTiₙX_{z} (3)
wherein a, j, k, 1, m and n are weight fractions satisfying 0.85≤a<1.0, and 0<j+k+1+m+n≤0.15; and
X includes at least one element selected from the group consisting of Cr, Fe, Co, Mn, Cu, Si, Nb, Na, Al, Mg, Zn, B, Ta, O, Sn, Ag, Re, Ru and Zr, or an alloy or compound of at least two elements selected therefrom.
